(19) United States
(12) Patent Application Publication
(10) Pub. No.: US 2011/0050913 A1
(43) Pub. Date: Mar. 3, 2011

(54) METHOD OF CONTROLLING DIGITAL PHOTOGRAPHING APPARATUS HAVING MEMORY, RECORDING MEDIUM FOR RECORDING THE METHOD, AND DIGITAL PHOTOGRAPHING APPARATUS

(75) Inventor: Hye-jin Kim, Suwon-si (KR)

(73) Assignee: Samsung Electronics Co., Ltd., Suwon-si (KR)

(21) Appl. No.: 12/862,932

(22) Filed: Aug. 25, 2010

(30) Foreign Application Priority Data
Aug. 28, 2009 (KR) 10-2009-0080693

(51) Int. Cl. H04N 5/225; H04N 5/76

(52) U.S. Cl. 348/207.1; 348/231.1; 348/E05.024

(57) ABSTRACT

A method of controlling a digital photographing apparatus having a memory for storing an image includes generating counter information corresponding to the image, determining whether the capacity of the memory is larger than a reference capacity, and selectively resizing or deleting the image according to the counter information when the capacity of the memory is larger than the reference capacity.

### CROSS-REFERENCE TO RELATED PATENT APPLICATION

This application claims the benefit of Korean Patent Application No. 10-2009-0080693, filed on Aug. 28, 2009, in the Korean Intellectual Property Office, the disclosure of which is incorporated herein in its entirety by reference.

### BACKGROUND

The present invention relates to a method of controlling a digital photographing apparatus, a recording medium for recording the method, and a digital photographing apparatus operating according to the method.

Digital photographing apparatuses generate images by photographing a variety of objects and store the images in a memory installed in each digital photographing apparatus. With the development of technology, the digital photographing apparatus generates and stores a high resolution image. However, since the memory installed in a portable digital photographing apparatus has a limited storage capacity, when high resolution images are stored, the number of images that can be stored is relatively reduced. When a user ignores managing the storage capacity of the memory, a desire image may not be stored due to a lack of the storage capacity.

### SUMMARY

The present invention provides a method of controlling a digital photographing apparatus including a memory having a limited storage capacity which enables a user to store desired images, a recording medium for recording the method, and a digital photographing apparatus operating according to the method.

According to an aspect of the present invention, there is provided a method of controlling a digital photographing apparatus having a memory for storing an image, which includes generating counter information corresponding to the image, determining whether the capacity of the memory is larger than a reference capacity, and selectively performing at least one of a resizing and a deleting the image according to the counter information when the capacity of the memory is larger than the reference capacity.

The method may further include generating the image by photographing an object, calculating position information of the digital photographing apparatus when the object is photographed, and generating the counter information according to the position information.

The method may further include calculating a distance from a reference position by using the position information, and generating the counter information according to the distance.

The method may further include setting at least one reference position, determining whether the position information belongs to the reference position, and generating the counter information according to the reference position to which the position information belongs.

The method may further include forming at least one folder in the memory, storing the image in the folder, generating first counter information corresponding to the folder where the image is stored, and generating second counter information corresponding to the image stored in the folder.

The method may further include connecting the digital photographing apparatus to an external digital device, transmitting the image stored in the memory to the external digital device, determining whether a method to connect the digital photographing apparatus to the external digital device is a wired method or a wireless method, and differently generating counter information of the image according to the wired or wireless method.

The method may further include connecting the digital photographing apparatus to an external digital device, transmitting the image stored in the memory to the external digital device, determining whether the transmitted image is stored in a non-volatile memory or a volatile memory of the external digital device, and differently generating counter information of the image according to whether the image is stored in a non-volatile memory or a volatile memory of the external digital device.

The method may further include comparing the counter information with reference information, resizing the image when the counter information is smaller than the reference information, and deleting the image when the counter information is larger than the reference information.

A plurality of images may be stored in the memory and counter information corresponding to each of the plurality of images may be generated. The method may further include grouping the plurality of images based on the counter information, and resizing or deleting images included in a group, in a lump sum.

The method may further include setting the number of images included in a group.

The method may further include generating an image file including the image and the counter information, and storing the image file in the memory.

The method may further include generating a database containing the counter information according to the image, and storing the database in an area of the memory different from the area of the memory where the image is stored.

According to another aspect of the present invention, there is provided a computer readable recording medium comprising a computer readable program code embodied therein, said computer readable program code adapted to be executed to implement the method for storing an image for the above digital photographing apparatus.

According to another aspect of the present invention, there is provided a digital photographing apparatus including a memory storing an image, a counter information generation unit that generates counter information corresponding to the image, a memory capacity determination unit that determines whether the memory capacity is larger than a reference capacity, and a unit that performs at least one of an image resizing and image deleting selectively resizing or deleting the image according to the counter information when the memory capacity is larger than the reference capacity.

The digital photographing apparatus may further include a position detection unit that generates position information of the digital photographing apparatus, wherein the counter information generation unit generates the counter information according to the position information.

The digital photographing apparatus may further include a distance calculation unit that calculates a distance from a reference position by using the position information, wherein the counter information generation unit generates the counter information according to the distance.

The digital photographing apparatus may further include a reference position setting unit that sets at least one reference position, and a position information determination unit that determines whether the position information belongs to the reference position, wherein the counter information generation unit generates the counter information according to a reference position to which the position information belongs.

The digital photographing apparatus may further include a folder forming unit that forms at least one folder, wherein the memory stores the image in a corresponding folder, and the counter information generation unit generates first counter information corresponding to the folder in which the image is stored and second counter information corresponding to the image stored in the folder.

The digital photographing apparatus may further include a communication unit connected to an external digital device that transmits the image stored in the memory to the external digital device, and a communication method determination unit that determines whether a method of communicating between the digital photographing apparatus and the external digital device is a wired method or a wireless method, wherein the counter information generation unit differently generates counter information of the image according to the wired or wireless method.

The digital photographing apparatus may further include a communication unit connected to an external digital device that transmits the image stored in the memory to the external digital device, and a transmission destination determination unit that determines whether the transmitted image is stored in a non-volatile memory or a volatile memory of the external digital device, wherein the counter information generation unit differently generates counter information of the image according to the non-volatile memory or the volatile memory where the image is stored.

The digital photographing apparatus may further include a photographing unit that generates a still image by photographing an object or motion picture by photographing the object, wherein the counter information generation unit differently generates counter information of the image according to the still image or the motion picture.

The digital photographing apparatus may further include a counter information comparison unit that compares the counter information with reference information, wherein the image resizing and deleting unit resizes the image when the counter information is smaller than the reference information and deletes the image when the counter information is larger than the reference information.

The digital photographing apparatus may further include a grouping unit that groups a plurality of images based on counter information when the plurality of images are stored in the memory and the counter information is generated for each of the plurality of images, wherein the image resizing and deleting unit resizes or deletes images included in a group, in a lump sum, when the memory capacity is larger than the reference capacity.

The digital photographing apparatus may further include an image number setting unit that sets the number of images included in a group.

The digital photographing apparatus may further include an image file generation unit that generates an image file including the image and the counter information, wherein the image file is stored in the memory.

The digital photographing apparatus may further include a database generation unit that generates a database containing the counter information according to the image, wherein the database is stored in an area of the memory different from the area of the memory where the image is stored.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a digital photographing apparatus according to an embodiment of the present invention;

FIG. 2 is a block diagram of a DSP of the digital photographing apparatus of FIG. 1, according to an embodiment of the present invention;

FIG. 3 is a block diagram of a DSP of the digital photographing apparatus of FIG. 1, according to another embodiment of the present invention;

FIG. 4 is a block diagram of a DSP of the digital photographing apparatus of FIG. 1, according to another embodiment of the present invention;

FIG. 5 is a block diagram of a DSP of the digital photographing apparatus of FIG. 1, according to another embodiment of the present invention;

FIG. 6 is a block diagram of a DSP of the digital photographing apparatus of FIG. 1, according to another embodiment of the present invention;

FIG. 7 is a block diagram of a DSP of the digital photographing apparatus of FIG. 1, according to another embodiment of the present invention;

FIG. 8 is a block diagram of a DSP of the digital photographing apparatus of FIG. 1, according to another embodiment of the present invention;

FIG. 9 is a block diagram of a DSP of the digital photographing apparatus of FIG. 1, according to another embodiment of the present invention;

FIG. 10 is a block diagram of a DSP of the digital photographing apparatus of FIG. 1, according to another embodiment of the present invention;

FIG. 11 is a block diagram of a DSP of the digital photographing apparatus of FIG. 1, according to another embodiment of the present invention;

FIG. 12 is a flowchart for explaining the operation of generating counter information with respect to a photographed image, in a method of controlling a digital photographing apparatus according to an embodiment of the present invention;

FIG. 13 is a pictorial diagram illustrating that two types of counter information are generated;

FIG. 14 is a flowchart for explaining the operation of generating counter information with respect to a transmitted image, in a method of controlling a digital photographing apparatus according to another embodiment of the present invention;

FIG. 15 illustrates that a digital camera that is an embodiment of the present invention communicates with a PC;

FIG. 16 illustrates that a digital camera that is an embodiment of the present invention communicates with a PC and a printer;

FIG. 17 is a flowchart for explaining the operation of resizing/deleting an image according to the counter information, in a method of controlling a digital photographing apparatus according to an embodiment of the present invention;

FIG. 18 is a pictorial diagram illustrating that at least two images are grouped into a group according to the counter information and the images in the group is resized/deleted in a lump sum, in a method of controlling a digital photographing apparatus according to an embodiment of the present invention; and

FIG. 19 is a flowchart for explaining the operation of selectively resizing or deleting an image according to the counter information, in a method of controlling a digital photographing apparatus according to another embodiment of the present invention.

### DETAILED DESCRIPTION OF THE EMBODIMENTS

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects of the present description.

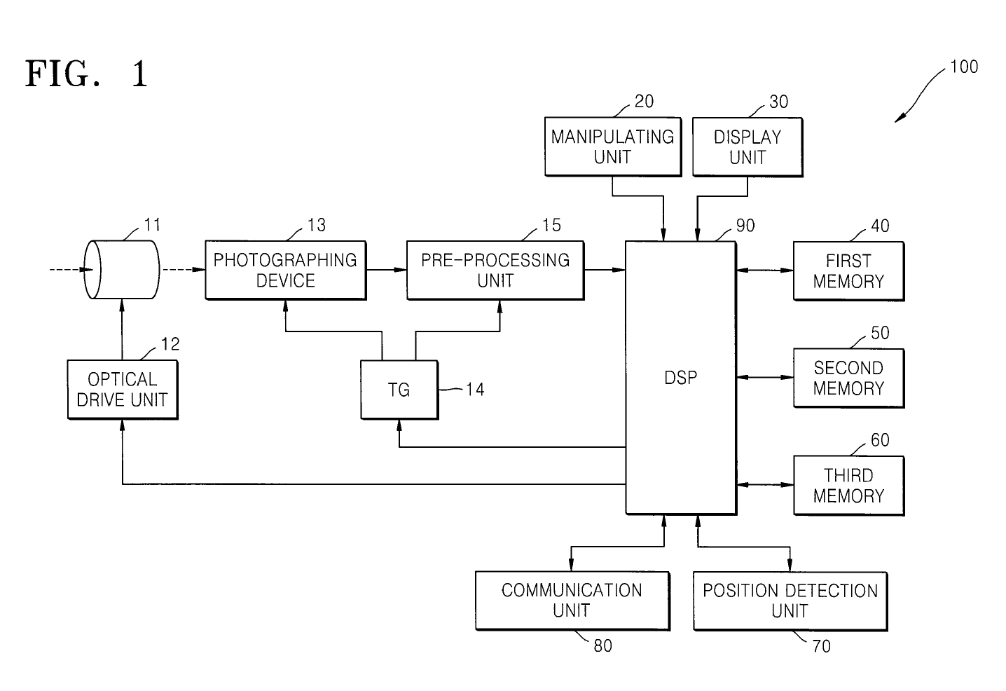

FIG. 1 is a block diagram of a digital photographing apparatus according to an embodiment of the present invention. In the present embodiment, a digital camera is described as an example of the digital photographing apparatus. However, the digital photographing apparatus is not limited to the digital camera and may be applied to digital apparatuses such as a camera telephone with a digital photographing apparatus, a personal digital assistant (PDA), a portable multimedia player (PMP), and a television set.

Referring to FIG. 1, a digital camera 100 includes an optical unit 11 receiving an optical signal from an object, an optical drive unit 12 driving the optical unit 11, a photographing device 13 converting the optical signal input through the optical unit 11 to an electric signal, a pre-processing unit 15 receiving an electric signal corresponding to a frame image from the photographing device 13 and performing signal processing such as converting the electric signal into a noise reduced digital signal, and a timing generator (TG) 14 controlling signal processing by the photographing device 13 and the pre-processing unit 15.

The optical unit 11 may include a lens focusing the optical signal, an aperture controlling the quantity of the optical signal, or the quantity of light, and a shutter controlling input of the optical signal. The lens may include a zoom lens controlling a viewing angle to be decreased or increased according to a focal length and a focus lens adjusting the focus of an object. Each of the lenses may be implemented by a single lens or a group of a plurality of lenses. The shutter may be a mechanical shutter with shutter blades moving up and down. The function of the shutter may be performed by controlling the supply of an electric signal to the photographing device 13, instead of using a separate shutter apparatus.

The optical drive unit 12 may drive position of the lens, opening/closing of the aperture, and operation of the shutter to carry out auto focusing, auto exposure adjustment, aperture adjustment, zooming, and focusing. The optical drive unit 12 may control the operation of the optical unit 11 by receiving a control signal from a digital signal processing unit (DSP) 90.

The photographing device 13 receives an optical signal input through the optical unit 11 and forms an image of the object. A complementary metal-oxide semiconductor (CMOS) sensor array or a charge coupled device (CCD) sensor array may be used as the photographing device 13. The photographing device 13 may provide image data corresponding to an image of a frame according to a timing signal supplied by the TG 14.

The pre-processing unit 15 may include an analog-to-digital (A/D) converter for digitalizing the electric signal supplied by the photographing device 13 that is an analog signal, thereby forming image data. Also, the pre-processing unit 15 may include a correlated double sampling circuit/an amplifier for adjusting gain or rectifying a waveform of the electric signal supplied by the photographing device 13.

The TG 14 may supply the timing signal to the photographing device 13 and the pre-processing unit 15, reading out electric charges with respect to each pixel by the photographing device 13 and the pre-processing unit 15 according to the timing signal, and control the pre-processing of a signal corresponding to the electric charges.

The DSP 90 performs image signal processing on the image data provided by the pre-processing unit 15. The DSP 90 not only performs signal processing on the image but also controls respective constituent elements according to information obtained from the image and/or a user's operation signal, as a function of a control unit. Although in the present embodiment the DSP 90 is implemented by a signal chip incorporating an image signal processing function and a control function, the present invention is limited thereto and the DSP 90 may be implemented by separate chips for the respective functions.

In detail, the DSP 90 may reduce noise in the image data, and perform image signal processing for enhancing image quality such as gamma correction, color filter array interpolation, color matrix, color correction, or color enhancement. Also, the DSP 90 may compress the image data generated by performing the image signal processing for enhancing image quality to thus generate an image file, or restore the image data from the image file. The image compression format may be of a reversible type or an irreversible type. For example, the conversion in a joint photographic experts group (JPEG) format or a JPEG 2000 format may be possible. The compressed image file may be stored in a third memory 60.

Also, the DSP 90 may functionally perform noise processing, color processing, blur processing, edge emphasis processing, image interpretation processing, image recognition processing, or image effect processing. The image recognition processing may include face recognition processing or scene recognition processing. In addition, the DSP 90 may perform processing a display image signal to be displayed on a display unit 30. For example, brightness level control, color correction, contrast control, edge emphasis control, screen division processing, character image generation, or image synthesis processing may be performed. The DSP 90 is connected to an external monitor and may perform predetermined image signal processing to be displayed on an external monitor and transmit the processed image data so that a corresponding image may be displayed on the external monitor.

The digital camera 100 includes a manipulating unit 20 for inputting user's operation signals and the display unit 30 displaying an image corresponding to the image data. The manipulating unit 20 may include a member to operate the digital camera 100 or set a variety of settings during photographing. For example, the manipulating unit 20 may be implemented by buttons, keys, touch panels, touch screens, or dials so that user operation signals such as power on/off, photographing start/stop, reproduction start/stop/search, operation of an optical system, mode change, menu operation, or selection operation may be input. Also, display devices such as liquid crystal displays (LCDs), organic light emitting devices (OLEDs), plasma display panels (PDPs), or electrophoresis display devices (EDDs) may be used as the display unit 30.

The digital camera 100 includes a first memory 40 temporarily storing the image data, a second memory 50 storing a program related to the operation of the digital camera 100, and the third memory 60 storing the image and/or necessary information. The DSP 90 may perform image signal processing and/or various operations in real time. However, when there is a difference between the transmission speed to the DSP 90 and the operation processing speed, the image data and/or data needed for the operation are temporarily stored in the first memory 40 and then the image data and/or the data needed for the operation are supplied to the DSP 90 from the first memory 40. Memory devices such as synchronous dynamic random access memories (SDRAMs), multi-chip packages (MCPs), or dynamic random access memories (DRAMs) may be used as the first memory 40.

The second memory 50 may store an operating system (OS) or application programs needed to operate the digital camera 100. Electrically erasable programmable read-only memories (E2PROMs), flash memories, or read-only memories (ROMs) may be used as the second memory 50.

The third memory 60 may store the image data that has been image signal processed. Secure digital (SD) cards/multimedia cards (MMCs), hard disk drives (HDDs), optical disks, optomagnetic disks, or hologram memories may be used as the third memory 60.

Also, the digital camera 100 includes a position detection unit 70 and a communication unit 80. The position detection unit 70 detects the position of the digital camera 100 and may be, for example, a global positioning system (GPS) receiver receiving position information data from a satellite. The communication unit 80 may transmit image to an external digital device by using a wireless communication method such as radio frequency identification (RFID) or wireless fidelity (Wi-Fi) or a wired communication method such as a cable.

Although in the present embodiment each constituent element is illustrated as a separate block, the present invention is not limited thereto and two or more constituent elements may be implemented by a single chip. Also, a constituent element performing two or more functions may be implemented by being separated into two or more chips corresponding to the number of functions.

A variety of embodiments of the DSP will be described in detail with reference to the accompanying drawings. The present invention includes not only each of DSPs according to various embodiments but also a DSP implemented by combining two or more different embodiments.

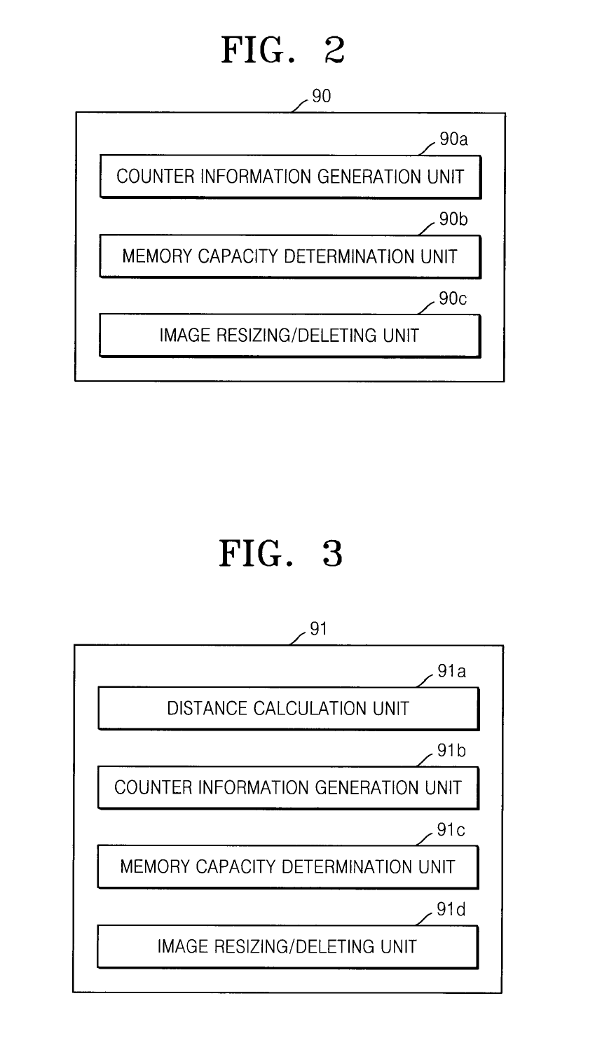

FIG. 2 is a block diagram of the DSP 90 of the digital photographing apparatus of FIG. 1, according to an embodiment of the present invention. Referring to FIGS. 1 and 2, the DSP 90 includes a counter information generation unit 90a, a memory capacity determination unit 90b, and an image resizing/deleting unit 90c.

The counter information generation unit 90a generates counter information corresponding to an image photographed by the digital camera 100. The counter information is information about a necessity of resizing or deleting the image photographed by the digital camera 100. That is, the counter information may be used to determine whether the necessity of resizing the image stored in the third memory 60 is high or low, or the necessity of deleting the image stored in the third memory 60 is high or low. As the necessity of resizing or deleting the image is higher, the counter information may be generated to be larger. The counter information is stored in the third memory 60 with the corresponding image. A method of generating the counter information will be described in detail below.

The memory capacity determination unit 90b compares the capacity of the third memory 60 for storing the image photographed by the digital camera 100 with a predetermined reference capacity. The comparison may include determining whether the capacity of the third memory 60 is full. When the capacity of the third memory 60 exceeds the reference capacity as a result of the comparison by the memory capacity determination unit 90b, a control signal corresponding to the comparison result is transmitted to the image resizing/deleting unit 90c.

When the capacity of the third memory 60 is larger than the reference capacity, the image resizing/deleting unit 90c resizes or delete the image stored in the third memory 60 according to the counter information corresponding to the image. For example, a first image and counter information of “0” corresponding to the first image and a second image and counter information of “1” corresponding to the second image are stored in the third memory 60. When the capacity of the third memory 60 is larger than the reference capacity, the image resizing/deleting unit 90c may selectively resize an image having the counter information of “0”, that is, only the first image. The first image is compressed and stored as a first image file in the third memory 60. The first image is restored from the first image file and the image resizing/deleting unit 90c may selectively resize the first image. Also, the image resizing/deleting unit 90c may selectively delete an image having the counter information of “1”, that is, only the second image. The second image may be compressed and stored as a second image file in the third memory 60 of FIG. 1. The image resizing/deleting unit 90c deletes the second image file corresponding to the deleting of the second image so that the storage capacity of the third memory 60 may be secured. Also, while the first image having smaller counter information may be resized, the second image having relatively larger counter information may be deleted. In the present embodiment, when the counter information is formed in proportion to the necessity of storage or preservation, an image having smaller counter information may be selectively resized or deleted. When the resizing and deleting are performed in parallel, the first image having a low necessity of storage or preservation, that is, small counter information, may be deleted and the second image having a high necessity of storage or preservation, that is, large counter information, may be resized. Thus, a user may secure a desired image at its maximum and efficiently use a limited memory space. The selectively resizing and/or deleting of images according to the counter information may be equally applied to the following embodiments.

FIG. 3 is a block diagram of a DSP 91 of the digital photographing apparatus of FIG. 1, according to another embodiment of the present invention. Referring to FIGS. 1 and 3, the DSP 91 according to the present embodiment includes a distance calculation unit 91a. The digital camera 100 includes the position detection unit 70 and may receive position information of the digital camera 100 photographing an object. The digital camera 100 may generate an image by photographing the object and receive the positional information by using the position detection unit 70. The generated image and the position information corresponding to image are stored in the third memory 60. The distance calculation unit 91a calculates a distance from a reference position by using the position information of the digital camera 100 obtained from the position detection unit 70.

The DSP 91 includes a counter information generation unit 91b that generates counter information corresponding to a distance. For example, an object is photographed at home, for example, in Seoul, Korea, to generate a first image and the position detection unit 70 receives position information (x1 in latitude, y1 in longitude). A distance d1 is calculated from a reference position (r in latitude, r in longitude) by using the position information (x1 in latitude, y1 in longitude). The distance d1 is digitalized to generate counter information of “00000001”. The photographed image and the counter information of “00000001” corresponding thereto are stored in the third memory 60. Another object is photographed in New York, U.S., to generate a second image. The position detection unit 70 receives position information (x2 in latitude, y2 in longitude). A distance d2 is calculated by using the position information (x2 in latitude, y2 in longitude). The distance d2 is digitalized to generate counter information of “11000100”. The photographed image and the counter information of “11000100” corresponding thereto are stored in the third memory 60. The third memory 60 stores the relationship between the image and the counter information as in Table 1.

TABLE 1

| Image | Counter Information |
|---|---|
| First image | 00000001 |
| Second image | 11000100 |

The DSP 91 includes a memory capacity determination unit 91c that compares the capacity of the third memory 60 with a reference capacity. The DSP 91 also includes an image resizing/deleting unit 91d that resizes or deletes an image according to the counter information when the capacity of the third memory 60 exceeds the reference capacity. When the capacity of the third memory 60 exceeds the reference capacity, the image resizing/deleting unit 91d may resize the image and store the resized image back in the third memory 60, or delete the image from the memory 60, in the order that the distance decreases, that is, the counter information increases. For example, when the capacity of the third memory 60 exceeds the reference capacity, the image resizing/deleting unit 91d may selectively resize or delete the first image having relatively smaller counter information. The first image may be adjusted based on an assumption that the counter number is formed to be smaller as the distance decreases. The number of images to be resized or deleted may be freely set by a user through the manipulating unit 20, or automatically set. The setting of the number of images subject to the resize or deletion may be equally applied to all embodiments.

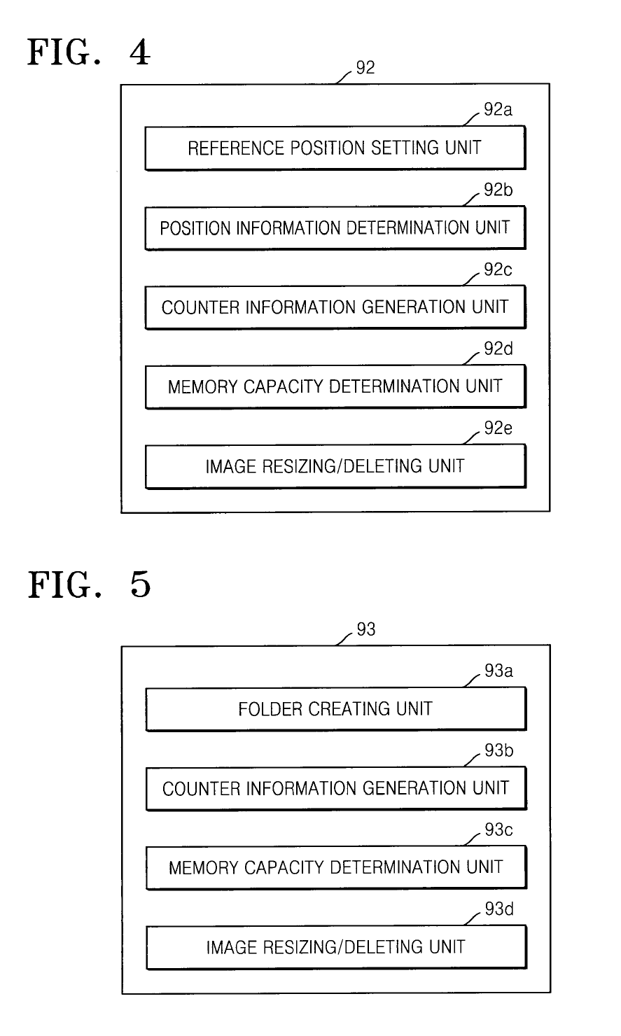

FIG. 4 is a block diagram of a DSP 92 of the digital photographing apparatus of FIG. 1, according to another embodiment of the present invention. Referring to FIGS. 1 and 4, the DSP 92 includes a reference position setting unit 92a. The reference position setting unit 92a may set positions in a manner, for example, “Home”, “Office”, or “Travel destination—New York”. The position may be set according to a user's operation signal input through the manipulating unit 20.

When a photographing position is determined to be “Home”, the counter information generation unit 92c may generate counter information of “0”. In the same manner, counter information of “1” may be set for “Office” and counter information of “2” may be set for “Travel destination—New York”. The image and counter information may be stored in the third memory 60 to have the relationship as shown in Table 2.

TABLE 2

| Image | Photographing Position | Counter Information |
|---|---|---|
| First image | Home | 0 |
| Second image | Office | 1 |
| Third image | Travel destination - New | 2 |
| | York | |

In the DSP 92, a memory capacity determination unit 92d compares the capacity of the third memory 60 with the reference capacity. When the capacity of the third memory 60 is greater than the reference capacity, an image resizing/deleting unit 92e may selectively resize a particular image and store the resized image again in the third memory 60, or delete the image from the third memory 60, according to the counter information. The necessity of storage or preservation for the third image photographed at “Travel destination—New York” is higher than that for the first image photographed at “Home” or the second image photographed at “Office”. Thus, the counter information is generated in proportion to the necessity of storage or preservation so that the counter information of the third image may be set to be the largest. When the capacity of the third memory 60 is greater than the reference capacity, the memory capacity determination unit 92d selectively resizes and stores again the first and second images having relatively smaller counter information, or delete the first and second images from the third memory 60.

FIG. 5 is a block diagram of a DSP 93 of the digital photographing apparatus of FIG. 1, according to another embodiment of the present invention. Referring to FIGS. 1 and 5, the DSP 93 includes a folder creating unit 93a creating a folder in the third memory 60. The folder may be freely created according to a user's operation signal input through the manipulating unit 20 or automatically by using an automatic classification function.

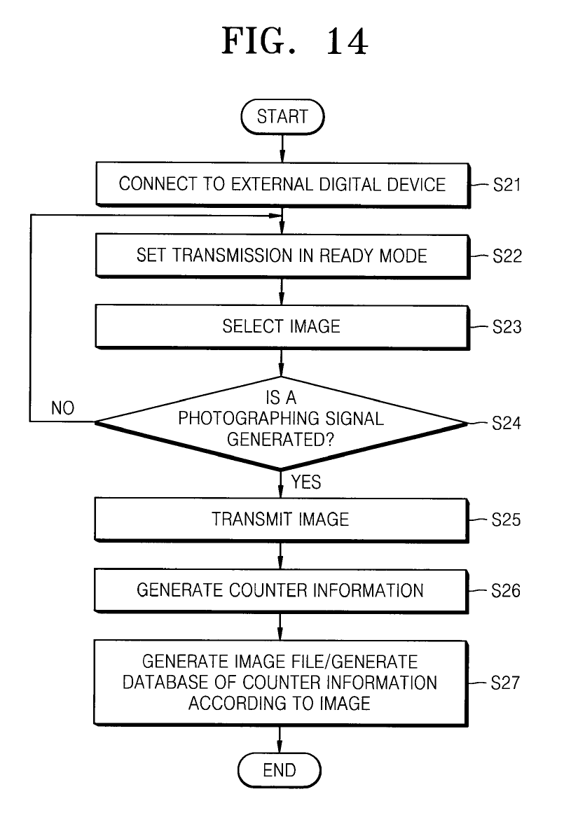

The image photographed by the digital camera 100 may be stored in the folder of the third memory 60. The counter information generation unit 93b may generate two types of counter information including first counter information representing the photographed image in the folder and second counter information about the image. The first and second counter information will be described in detail with reference to FIG. 14. The first and second counter information may be stored in the third memory 60 in relation to the photographed image.

A memory capacity determination unit 93c determines whether the capacity of the third memory 60 is greater than the reference capacity. When the capacity of the third memory 60 is greater than the reference capacity, an image resizing/deleting unit 93d may selectively resize or delete the image stored in the third memory 60 according to the first and second counter information. Priority may be given to the first counter information over the second counter information. The image in the folder corresponding to small first counter information may be resized or deleted. Furthermore, of the images in the folder corresponding to relatively smaller first counter information, an image corresponding to relatively smaller second counter information is selectively resized or deleted.

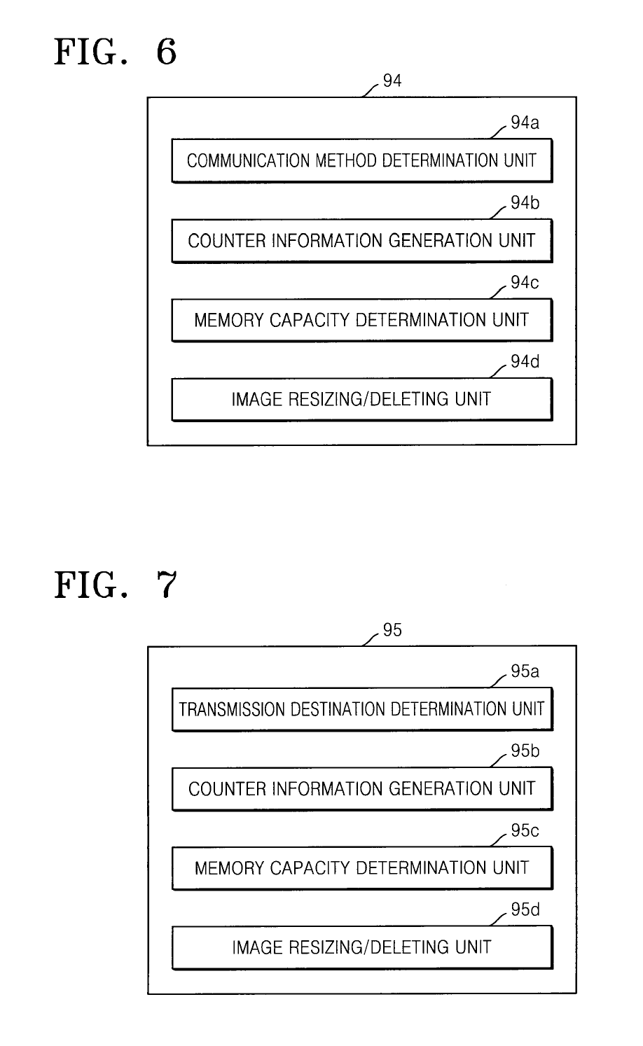

FIG. 6 is a block diagram of a DSP 94 of the digital photographing apparatus of FIG. 1, according to another embodiment of the present invention. Referring to FIGS. 1 and 6, the digital camera 100 may copy and transmit the image stored in the third memory 60 to an external digital device such as a printer or a PC via the communication unit 80.

The communication method determination unit 94a determines a communication method between the digital camera 100 and the external digital device by detecting the connection state between the digital camera 100 and the external digital device. For example, when the digital camera 100 and the external digital device are connected by a wired method using a cable, an interface (not shown) connecting the cable to the digital camera 100 is activated and a program for cable communication may be initialized. Also, when the digital camera 100 and the external digital device are connected wirelessly, a communication unit (not shown) for wireless communication is activated and a program for wireless communication may be initialized. The communication method determination unit 94a may determine the communication method from each of the above operations. When an image is copied and transmitted from the digital camera 100 to the external digital device, the counter information generation unit 94b may generate counter information corresponding to the communication method determined by the communication method determination unit 94a.

For example, when the digital camera 100 transmits a first image to the external digital device in a wired communication method, counter information may be set to be “0” corresponding to the transmitted first image. When the digital camera 100 transmits a second image to the external digital device in a wireless communication method, counter information may be set to be “1” corresponding to the transmitted second image. The reliability in the transmission by the wired communication method is higher than that by the wireless communication method. Accordingly, a probability of the first image being copied and transmitted to the external digital device that is a target device by the wired communication method is higher than that by the wireless communication method. Thus, the digital camera 100 may determine that the necessity of storage or preservation for the second image is higher than that for the first image and thus set counter information to be a large value.

When the memory capacity determination unit 94c determines that the capacity of the third memory 60 is larger than the reference capacity, the image resizing/deleting unit 94d may resize or delete the image according to the counter information. When the third memory 60 stores the first and second images and the counter information corresponding to each of the images, and the memory capacity determination unit 94c determines that the capacity of the third memory 60 is larger than the reference capacity, the image resizing/deleting unit 94d may resize the first image having a smaller counter information, that is, the counter information of “0”, and stores the resized first image in the third memory 60, or delete the first image. Also, the first image having the counter information of “0” is deleted and the second image having the counter information of “1” is resized. Thus, a memory space may be obtained by a selective method according to an automatic resizing/deleting mode.

FIG. 7 is a block diagram of a DSP 95 of the digital photographing apparatus of FIG. 1, according to another embodiment of the present invention. Referring to FIG. 7, the DSP 95 includes a transmission destination determination unit 95a. When the digital camera 100 copies and transmits an image to an external digital device, the transmission destination determination unit 95a determines in which type of a memory of the external digital device the transmitted image is stored. For example, when the image is copied and transmitted from the digital camera 100 to a printer, the printer temporarily stores the received image in a volatile memory for printing. In contrast, the image is copied and transmitted from the digital camera 100 to a PC, the PC stores the received image in a non-volatile memory.

A case of transmitting an image to a printer and storing the image in a volatile memory may have a relatively higher necessity of storage or preservation of the image than a case of storing the image in a non-volatile memory of a PC. Thus, the transmission destination determination unit 95a determines whether the image transmitted to the external digital device is stored in a non-volatile memory or in a volatile memory.

The transmission destination determination unit 95a may determine the type of a memory according to the type of the external digital device connected to the digital camera 100. That is, when the digital camera 100 is connected to a printer, the transmission destination determination unit 95a may determine the transmission destination as a volatile memory. When the digital camera 100 is connected to a PC, the transmission destination determination unit 95a may determine the transmission destination as a non-volatile memory.

A counter information generation unit 95b may generate counter information for a transmitted image based on transmission destination information from the transmission destination determination unit 95a. When the first image is transmitted to a non-volatile memory, the counter information of the first image may be set to be “0”. When the second image is transmitted to a volatile memory, the counter information of the second image may be set to be “1”.

When a memory capacity determination unit 95c determines that the capacity of the third memory 60 is larger than the reference capacity, an image resizing/deleting unit 95d may resize or delete the image according to the counter information. For example, a first image having counter information of “0” may be deleted and a second image having counter information of “1” may be resized.

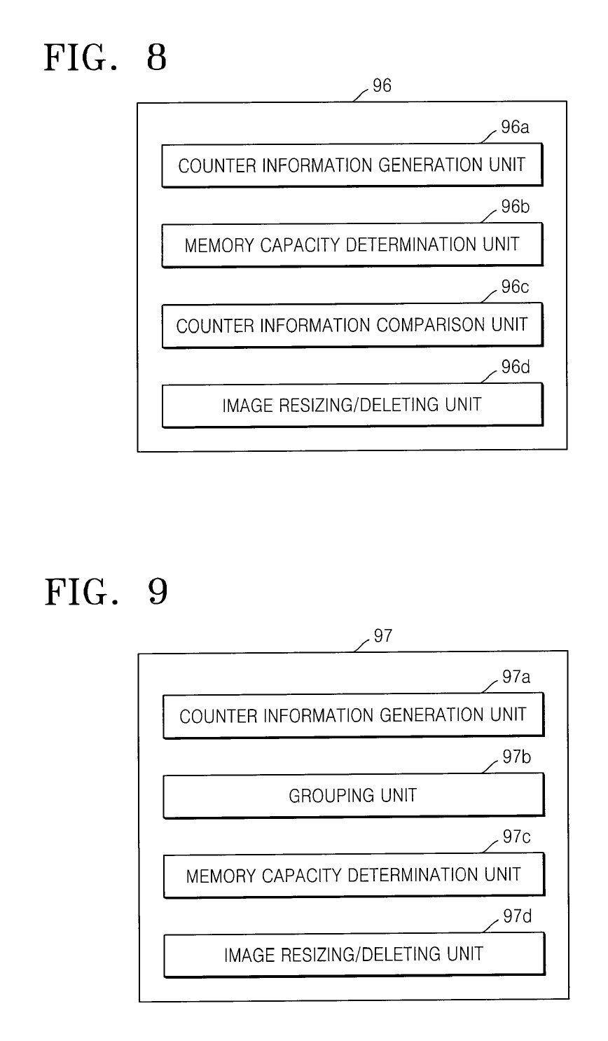

FIG. 8 is a block diagram of a DSP 96 of the digital photographing apparatus of FIG. 1, according to another embodiment of the present invention. Referring to FIGS. 1 and 8, the DSP 96 includes a counter information generation unit 96a generating counter information with respect to a photographed image or a transmitted image. A memory capacity determination unit 96b compares the capacity of the third memory 60 with the reference capacity. When the memory capacity determination unit 96b determines whether the capacity of the third memory 60 is larger than the reference capacity, a counter information comparison unit 96c compares the counter information with the reference information. When the counter information is smaller than the reference information, an image resizing/deleting unit 96d may delete the image. When the counter information is larger than the reference information, the image resizing/deleting unit 96d may resize the image. The operation is based on an assumption that the necessity of storage or preservation decreases as the counter information decreases.

FIG. 9 is a block diagram of a DSP 97 of the digital photographing apparatus of FIG. 1, according to another embodiment of the present invention. Referring to FIGS. 1 and 9, the DSP 97 includes a counter information generation unit 97a generating counter information with respect to a photographed image or a transmitted image. The counter information generated by the counter information generation unit 97a is stored in the third memory 60 by being connected to the corresponding image. A memory capacity determination unit 97c compares the capacity of the third memory 60 with the reference capacity. When the memory capacity determination unit 97c determines whether the capacity of the third memory 60 is larger than the reference capacity, an image resizing/deleting unit 97d may resize or delete the image. The DSP 97 groups image according to the counter information so that the image resizing/deleting unit 97d may resize or delete the grouped images in a lump sum. A grouping unit 97b may set the number of images included in a group according to a user's operation signal input through the manipulating unit 20. For example, when twenty (20) images having counter information of “0” and seventy (70) images having counter information of “1” are stored in the third memory 60, by setting the twenty images to be included in a group, the twenty images having the counter information of “0” may be resized or deleted in a lump sum. When the number of image forming a group is different from the number of images having the same counter information, the number of image forming a group may be reset. Some images only may be selectively resized or deleted by considering counter information among the images belong to a group or a different group.

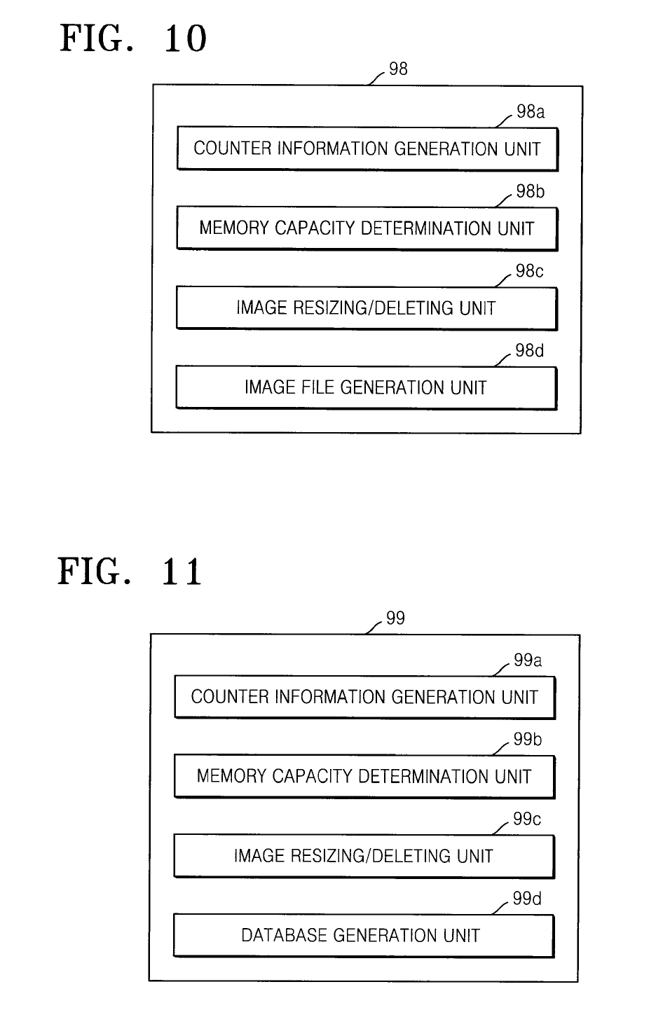

FIG. 10 is a block diagram of a DSP 98 of the digital photographing apparatus of FIG. 1, according to another embodiment of the present invention. Referring to FIGS. 1 and 10, DSP 98 according to the present exemplary embodiment includes a counter information generation unit 98a generating counter information with respect to a photographed image or a transmitted image and an image file generation unit 98d generating an image file including the generated counter information and the image. The image file may be stored in the third memory 60. A memory capacity determination unit 98b compares the capacity of the third memory 60 with the reference capacity. When the memory capacity determination unit 98b determines that the capacity of the third memory 60 is larger than the reference capacity, an image resizing/deleting unit 98c generates counter information from the image file. An image may be restored from the image file according to the generated counter information and a restored image may be resized. The image file including the image resized by the image file generation unit 98d and the counter information is regenerated and the regenerated image file may be stored in the third memory 60. Also, the image resizing/deleting unit 98c may delete the image file stored in the third memory 60 according to the counter information generated from the image file.

FIG. 11 is a block diagram of a DSP 99 of the digital photographing apparatus of FIG. 1, according to another embodiment of the present invention. Referring to FIGS. 1 and 11, the DSP 99 according to the present exemplary embodiment includes a counter information generation unit 99a generating counter information with respect to a photographed image or a transmitted image and a database generation unit 99d generating database containing counter information corresponding to the image. A memory capacity determination unit 99b compares the capacity of the third memory 60 with the reference capacity. When the memory capacity determination unit 99b determines that the capacity of the third memory 60 is larger than the reference capacity, an image resizing/deleting unit 99c may resize or delete the image according to the counter information generated from the database.

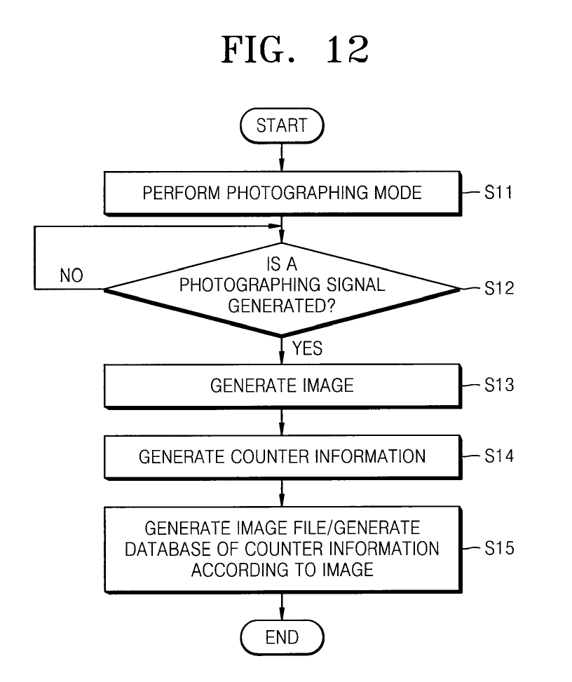

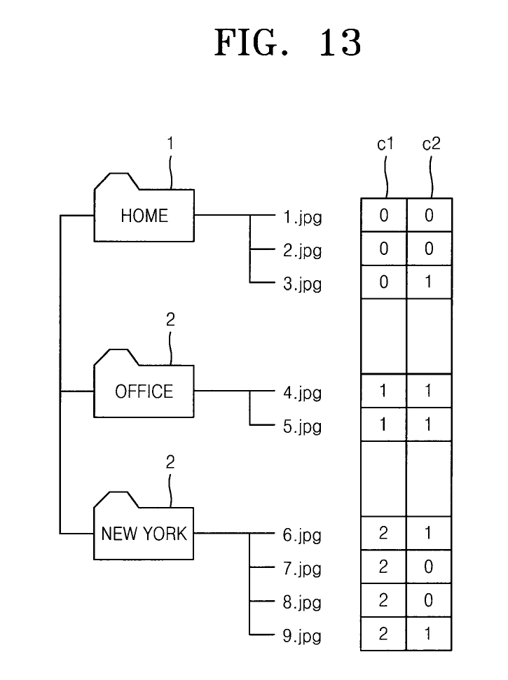

A variety of exemplary embodiments of a method of controlling a digital photographing apparatus according to the present inventive concept will be described below. FIG. 12 is a flowchart for explaining the operation of generating counter information with respect to a photographed image, in a method of controlling a digital photographing apparatus according to an embodiment of the present invention. FIG. 13 illustrates that two types of counter information are generated.

Referring to FIG. 12, a photographing mode is performed (S11). It is determined whether a photographing signal is generated (S12). For example, a photographing signal to capture an object may be generated by pressing a shutter-release button. When the photographing signal is generated, the object is photographed to generate an image (S13). Then, position information of a digital camera at the time the photograph is taken is received and counter information corresponding the received position information is generated (S14). While the photographing signal is not generated, it is continuously determined whether the photographing signal is generated.

A distance may be calculated from a reference position by using the position information and counter information corresponding to the calculated distance may be generated. Also, it is determined whether the digital photographing apparatus is positioned at a set reference place by using the position information, and counter information corresponding to the reference position may be generated.

Also, by generating a plurality of folders in a memory and storing a generated image in any one of the folders, first counter information may be generated corresponding to the any one of the folders and second counter information may be generated corresponding to the image stored in the any one of the folders.

For example, referring to FIG. 13, three folders are set according to the positions, for example, “Home”, “Office”, and “New York”. The first image is generated by photographing the object. When the position information of the digital camera during which the first image is photographed is in the position range corresponding to “Home”, a first image file 1.jpg including the first image is stored in the “Home” folder. In the same manner, a second image file 2.jpg and a third image file 3.jpg are stored in the “Home” folder. A fourth image file 4.jpg and a fifth image file 5.jpg are stored in the “Office” folder. A sixth image file 6.jpg, a seventh image file 7.jpg, an eighth image file 8.jpg, and a ninth image file 9.jpg are stored in the “New York” folder.

For each image file, first counter information c1 corresponding to a folder and a second counter information c2 corresponding to an image are generated. When one of the image files is stored in the “Home” folder, a value “0” is generated as first counter information for the one. For the “Office” folder, a value “1” is generated as the first counter information. For the “New York” folder, a value “2” is generated as the first counter information. When the second counter information c2 is generated according to the photographing time, second counter information c2 may be formed to be a smaller value as the photographing time increases with respect to the imaged in the folder. When the image files are generated for the same photographing time, the second counter information c2 may be equally set. Thus, two types of counter information may be generated for the photographed image as illustrated in FIG. 13.

An image file including the generated counter information and the photographed image is generated and stored, or a database containing the counter information generated according to the image is generated (S15).

FIG. 14 is a flowchart for explaining the operation of generating counter information with respect to a transmitted image, in a method of controlling a digital photographing apparatus according to another embodiment of the present invention. Referring to FIG. 14, a digital camera is connected to an external digital device (S21). A communication unit of the digital camera is initialized to perform communication with the external digital device and transmission is in a ready mode (S22). An image to be transmitted is selected (S23). It is determined whether a transmission signal is generated (S24). When the transmission signal is not generated, transmission is still in a ready mode (S22). When the transmission signal is generated, a selected image is copied and transmitted to the external digital device (S25).

Counter information is generated with respect to the transmitted image (S26). An image file including the image and the generated counter information is generated or stored, or a database containing the generated counter information according to the image is generated (S27).

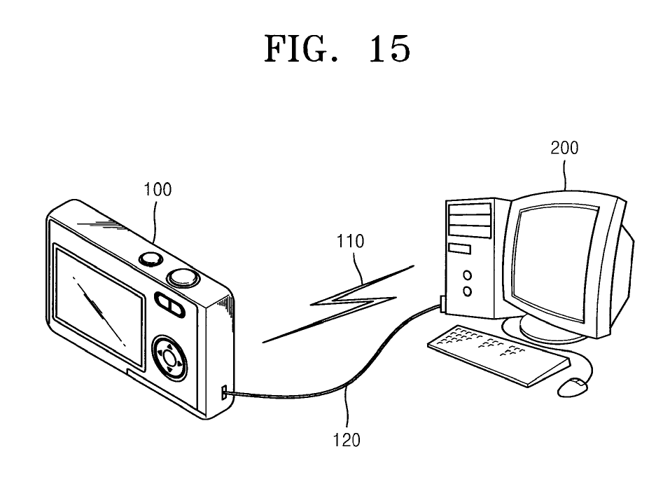

In an exemplary embodiment, referring to FIG. 15, the counter information may be differently generated according to the type of a communication method, for example, in a wireless method 110 or a wired method 120, between the digital camera 100 and a PC 200 as the external digital device.

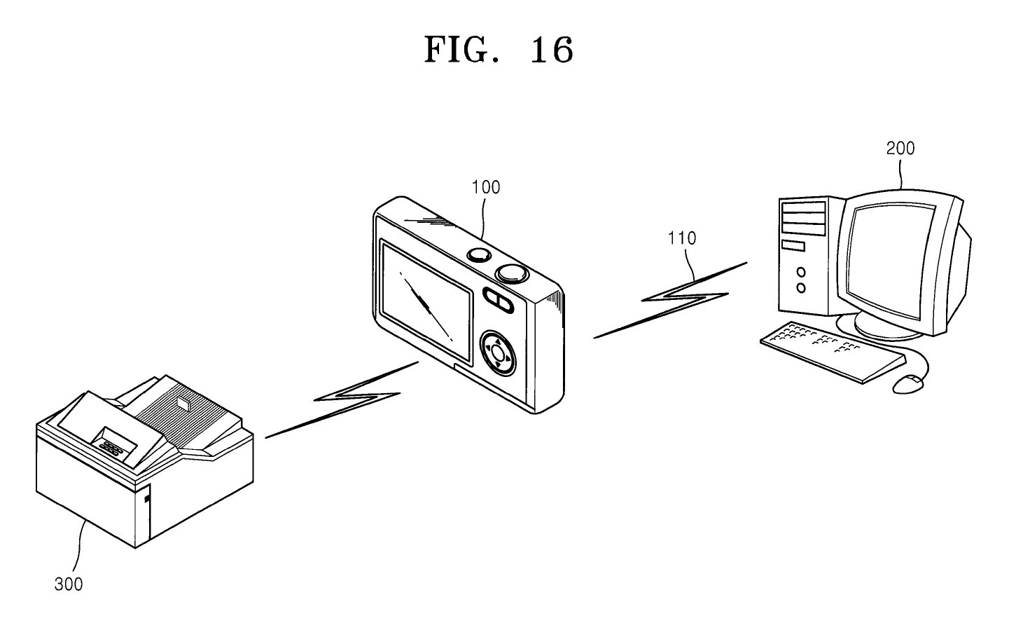

In another exemplary embodiment, referring to FIG. 16, the counter information may be differently generated according to a place where an image is transmitted from the digital camera 100 and finally stored, that is, a transmission destination. For example, the counter information may be differently generated in a case in which the image is transmitted to the PC 200 and in a case in which the image is transmitted to a printer 300. When the image is stored in the PC 200, the transmitted image is stored in the non-volatile memory. Thus, the necessity of storage or preservation of the image in the digital camera 100 is relatively decreased. In contrast, when the image is transmitted to the printer 300, the image is temporarily stored in the volatile memory and then is output. Thus, for the image transmitted to the printer 300, the necessity of storage or preservation of the image in the digital camera is relatively increased. Thus, the counter information may be differently generated according to a place where an image is transmitted from the digital camera 100 and stored.

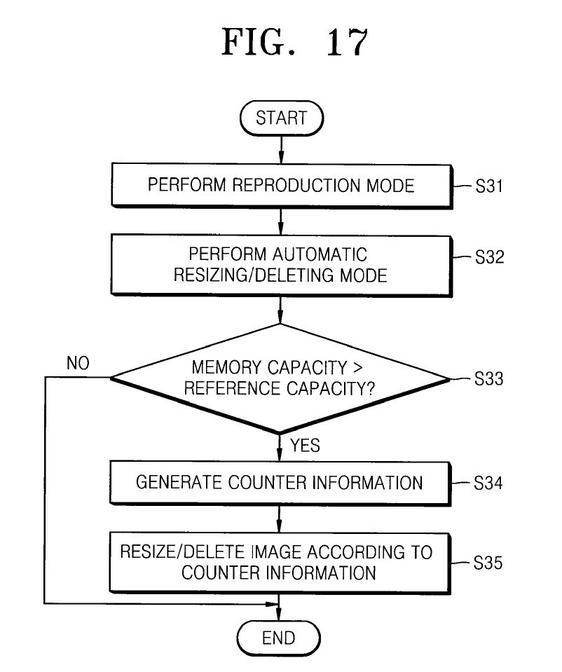

FIG. 17 is a flowchart for explaining the operation of resizing/deleting an image according to the counter information, in a method of controlling a digital photographing apparatus according to an embodiment of the present invention. Referring to FIG. 17, a reproduction mode is performed (S31). An automatic resizing/deleting mode is performed (S32). The capacity of a memory storing images is compared with the reference capacity (S33). When the capacity of a memory is larger than the reference capacity, counter information is generated (S34). The image is resized or deleted according to the generated counter information (S35). When the capacity of a memory is smaller than the reference capacity, the automatic resizing/deleting mode is terminated.

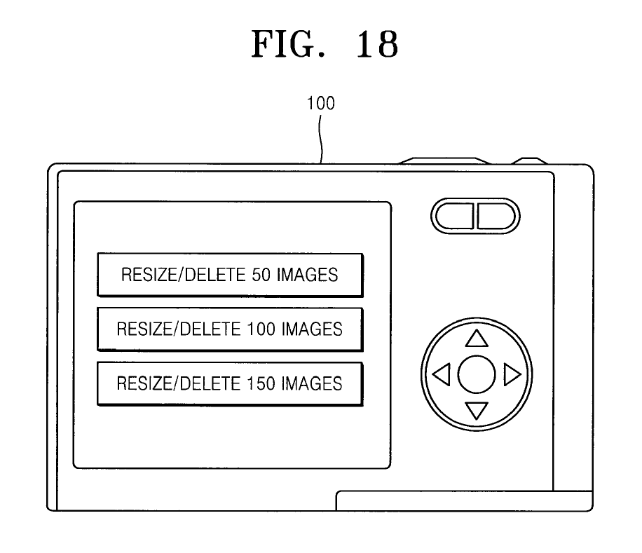

FIG. 18 illustrates that at least two images are grouped into a group according to the counter information and the images in the group is resized/deleted in a lump sum, in a method of controlling a digital photographing apparatus according to an embodiment of the present invention. Referring to FIG. 18, a user interface (UI) to guide setting of the number of images forming a group is provided by a user's input. For example, a first UI to form fifty (50) images into a group and resize/delete the fifty images in a lump sum, a second UI to form hundred (100) images into a group and resize/delete the hundred images in a lump sum, and a third UI to form one hundred and fifty (150) images into a group and resize/delete the one hundred and fifty images in a lump sum are displayed on the display unit 30. A user selects any one of the first through third UIs and resizes or deletes the selected number of images according to the counter information in a lump sum.

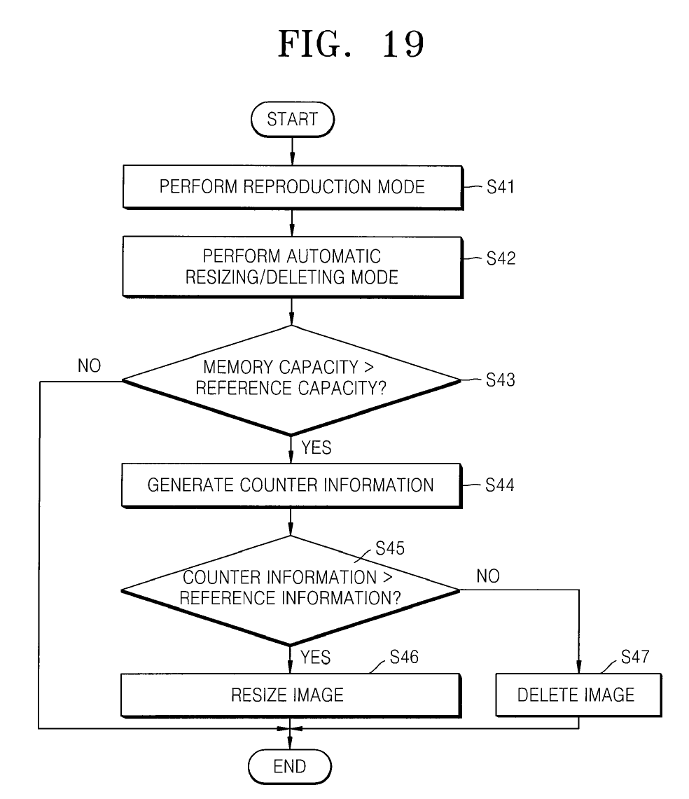

FIG. 19 is a flowchart for explaining the operation of selectively resizing or deleting an image according to the counter information, in a method of controlling a digital photographing apparatus according to another embodiment of the present invention. Referring to FIG. 19, a reproduction mode is performed (S41). An automatic resizing/deleting mode is performed (S42). The capacity of a memory storing images and counter information is compared with the reference capacity (S43). When the capacity of a memory is larger than the reference capacity, the counter information is generated (S44). The generated counter information is compared with the reference information (S45). Assuming that the necessity of storage or preservation decreases as the counter information decreases, when the counter information is larger than the reference information, the image corresponding to the generated counter information is resized (S46). When the counter information is smaller than the reference information, the image is deleted (S47).

According to the recent memory technology, hundreds to thousands of images may be stored according to the resolution. When the memory capacity is insufficient, the memory space storing hundreds to thousands of images may be efficiently managed by selectively resizing or deleting the images by using the counter information corresponding to the necessity of storage or preservation, not by equally resizing or deleting all images, based on this memory technology.

In particular, in view of the necessity of storage or preservation, by giving a higher priority to a second image photographed in a travel place difficult to access from everyday life (e.g., a vacation location) than to a first image photographed in a place for everyday life that is easy to access, by using position information, the counter information of the second image is set to be higher than that of the first image. Accordingly, when the memory capacity is insufficient, the first image having lower counter information is selectively resized or deleted.

Also, when an image is transmitted from the digital photographing apparatus to the external digital device, counter information may be generated corresponding to the necessity of storage or preservation according to the reliability in a communication method and the transmission destination. The counter information of the second image transmitted in a wireless communication method having relatively lower transmission reliability is set to be smaller than that of the first image transmitted in a wired communication method having relatively higher transmission reliability. Also, the counter information when the image is stored in the non-volatile memory is set to be larger than that when the image is stored in a non-volatile memory where the image transmitted by the external digital device may be stored or preserved. When the memory capacity is insufficient, the image having smaller counter information may be selectively resized or deleted. It is not determined that the necessity of storage or preservation is high simply because of the existence of transmission to the external digital device. As described above, even a copied and transmitted image may have remarkably varying necessity of storage or preservation according to the transmission reliability or the type of transmission destination. Thus, the present inventive concept provides a method of controlling a digital photographing apparatus in which counter information is generated for a copied and transmitted image according to a communication method or the type of a transmission destination and some of images are selectively resized or deleted based on the generated counter information, a digital photographing apparatus operating according to the method, and a recording medium for recording the method.

Therefore, in a memory storing hundreds to thousands of images, some of images may be selectively resized or deleted without checking each of the images, by using the counter information corresponding to the necessity of storage or preservation. Also, in checking the images in a reproduction mode of the digital photographing apparatus, the images are sequentially checked according to the display order of the images regardless of the selection by a user. It is more objective to resize or delete some of images according to the counter information related to the necessity of storage or preservation than to selectively resize or delete some images based on the priority order generated according to the frequency of checks by the user. As a result, user's satisfaction in the use of products may be greatly improved.

As described above, according to the one or more of the above embodiments of the present invention, a digital photographing apparatus which may efficiently manage a memory having a limited storage capacity, a method of controlling the digital photographing apparatus, and a recording medium for recording the method are provided.

Software modules may be used to implement various above-described functionality. These software modules may be stored as program instructions or computer readable codes executable on the processor on a computer-readable media such as read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion. This media can be read by the computer, stored in the memory, and executed by the processor.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Functional aspects may be implemented in algorithms that execute on one or more processors. Furthermore, the present invention could employ any number of conventional techniques for electronics configuration, signal processing and/or control, data processing and the like. The words “mechanism” and “element” are used broadly and are not limited to mechanical or physical embodiments, but can include software routines in conjunction with processors, etc.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”.

The use of the terms “a” and “an” and “the” and similar referents in the context of describing the invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed.

Numerous modifications and adaptations will be readily apparent to those skilled in this art without departing from the spirit and scope of the present invention.

What is claimed is:

1. A method of controlling a digital photographing apparatus having a memory for storing an image, the method comprising:
generating counter information corresponding to the image;
determining whether the capacity of the memory is larger than a reference capacity; and
selectively performing at least one of a resizing and a deleting of the image according to the counter information when the capacity of the memory is larger than the reference capacity.

2. The method of claim 1, further comprising:
generating the image by photographing an object;
calculating position information of the digital photographing apparatus when the object is photographed; and
generating the counter information according to the position information.

3. The method of claim 2, further comprising:
calculating a distance from a reference position by using the position information; and
generating the counter information according to the distance.

4. The method of claim 2, further comprising:
setting at least one reference position;
determining whether the position information belongs to the reference position; and
generating the counter information according to the reference position to which the position information belongs.

5. The method of claim 1, further comprising:
forming at least one folder in the memory;
storing the image in the folder;
generating first counter information corresponding to the folder where the image is stored; and
generating second counter information corresponding to the image stored in the folder.

6. The method of claim 1, further comprising:
connecting the digital photographing apparatus to an external digital device;
transmitting the image stored in the memory to the external digital device;
determining whether a method to connect the digital photographing apparatus to the external digital device is a wired method or a wireless method; and
differently generating counter information of the image according to the wired or wireless method.

7. The method of claim 1, further comprising:
connecting the digital photographing apparatus to an external digital device;
transmitting the image stored in the memory to the external digital device;
determining whether the transmitted image is stored in a non-volatile memory or a volatile memory of the external digital device; and
differently generating counter information of the image according to whether the image is stored in a non-volatile memory or a volatile memory of the external digital device.

8. The method of claim 1, further comprising:
comparing the counter information with reference information;
resizing the image when the counter information is smaller than the reference information; and
deleting the image when the counter information is larger than the reference information.

9. The method of claim 1, wherein a plurality of images are stored in the memory and counter information corresponding to each of the plurality of images are generated, the method further comprising:
grouping the plurality of images based on the counter information; and
resizing or deleting images included in a group, in a lump sum.

10. The method of claim 9, further comprising setting the number of images included in a group.

11. The method of claim 1, further comprising:
generating an image file including the image and the counter information; and
storing the image file in the memory.

12. The method of claim 1, further comprising:
generating a database containing the counter information according to the image; and
storing the database in an area of the memory different from the area of the memory where the image is stored.

13. A computer readable recording medium comprising a computer readable program code embodied therein, said computer readable program code adapted to be executed to implement a method for storing an image, said method comprising:
generating counter information corresponding to the image;
determining whether the capacity of the memory is larger than a reference capacity; and
selectively resizing or deleting the image according to the counter information when the capacity of the memory is larger than the reference capacity.

14. A digital photographing apparatus comprising:
a memory that stores an image;
a counter information generation unit that generates counter information corresponding to the image;
a memory capacity determination unit that determines whether the memory capacity is larger than a reference capacity; and
a unit that performs at least one of an image resizing and image deleting selectively resizing or deleting the image according to the counter information when the memory capacity is larger than the reference capacity.

15. The digital photographing apparatus of claim 14, further comprising a position detection unit that generates position information of the digital photographing apparatus, wherein the counter information generation unit generates the counter information according to the position information.

16. The digital photographing apparatus of claim 15, further comprising a distance calculation unit that calculates a distance from a reference position by using the position information,
wherein the counter information generation unit generates the counter information according to the distance.

17. The digital photographing apparatus of claim 15, further comprising:
a reference position setting unit that sets at least one reference position; and
a position information determination unit that determines whether the position information belongs to the reference position,
wherein the counter information generation unit generates the counter information according to a reference position to which the position information belongs.

18. The digital photographing apparatus of claim 14, further comprising a folder forming unit that forms at least one folder,
wherein the memory stores the image in a corresponding folder, and the counter information generation unit generates first counter information corresponding to the folder in which the image is stored and second counter information corresponding to the image stored in the folder.

19. The digital photographing apparatus of claim 14, further comprising:
a communication unit connected to an external digital device that transmits the image stored in the memory to the external digital device; and
a communication method determination unit that determines whether a method of communicating between the digital photographing apparatus and the external digital device is a wired method or a wireless method,
wherein the counter information generation unit differently generates counter information of the image according to the wired or wireless method.

20. The digital photographing apparatus of claim 14, further comprising:
a communication unit connected to an external digital device that transmits the image stored in the memory to the external digital device; and
a transmission destination determination unit that determines whether the transmitted image is stored in a non-volatile memory or a volatile memory of the external digital device,
wherein the counter information generation unit differently generates counter information of the image according to the non-volatile memory or the volatile memory where the image is stored.

21. The digital photographing apparatus of claim 14, further comprising a photographing unit that generates a still image by photographing an object or motion picture by photographing the object,
wherein the counter information generation unit differently generates counter information of the image according to the still image or the motion picture.

22. The digital photographing apparatus of claim 14, further comprising a counter information comparison unit that compares the counter information with reference information,
wherein the unit resizes the image when the counter information is smaller than the reference information and deletes the image when the counter information is larger than the reference information.

23. The digital photographing apparatus of claim 14, further comprising a grouping unit that groups a plurality of images based on counter information when the plurality of images are stored in the memory and the counter information is generated for each of the plurality of images,
wherein the unit resizes or deletes images included in a group, in a lump sum, when the memory capacity is larger than the reference capacity.

24. The digital photographing apparatus of claim 23, further comprising an image number setting unit that sets the number of images included in a group.

25. The digital photographing apparatus of claim 14, further comprising an image file generation unit that generates an image file including the image and the counter information,
wherein the image file is stored in the memory.

26. The digital photographing apparatus of claim 14, further comprising a database generation unit that generates a database containing the counter information according to the image,
wherein the database is stored in an area of the memory different from the area of the memory where the image is stored.
